(19) United States
(12) Patent Application Publication
(10) Pub. No.: US 2009/0146095 A1
(43) Pub. Date: Jun. 11, 2009

(54) Drainable radial diaphragm valve

(76) Inventor: Marc Baril, Hollis, NH (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/001,501

(22) Filed: Dec. 11, 2007

(51) Int. Cl. F16K 1/00

(52) U.S. Cl. 251/331

(57) ABSTRACT

A drainable radial diaphragm valve includes a valve body that defines a valve cavity, and an inlet passage and an outlet passage. The valve body may include a valve seat at an end of the inlet passage, where the inlet passage joins and creates a flow path into the valve cavity, and a port at an end of the outlet passage, where the outlet passage joins and creates a flow path from the valve cavity. A surface of the valve body may slope from the valve seat downward to the port of the outlet passage. A flexible diaphragm including the protruding boss may be mounted with the boss aligned with the valve seat to contact and seal the valve seat, and close the flow path from the inlet passage into the valve cavity when the diaphragm is flexed to axially displace the boss toward the valve seat.

### BACKGROUND

Radial diaphragm valves are used in high-purity or sanitary fluid-distribution systems, such as chromatography systems, filtration skids, water-for-injection systems (distillation or reverse-osmosis systems for purifying water), and bioreactors. These critical fluid systems dictate the use of non reactive materials, such as stainless steel and inert fluoropolymers, that will not contaminate fluids flowing there through. The internal geometry of the valve should also allow for drainage of process fluids when in the closed state. Many of the known valve designs do not provide for adequate drainage without altering the traditional raised central boss valve cavity configuration. Existing valves also tend to lack a compliant sealing method between the valve cavity and flexible diaphragm that accommodates the cold flow characteristics of fluoropolymer materials when put under compressive loads to achieve a leak tight fluidic seal.

One example of an earlier valve design is described in U.S. Pat. No. 5,549,134.

### SUMMARY

A drainable radial diaphragm valve of this disclosure includes a valve body that defines two passages (one of which serves as an inlet passage and the other of which serves as an outlet passage), and a valve cavity. The valve body includes a valve seat at an end of one of the passages (serving, e.g., as the “inlet” passage), where the passage joins and creates a flow path into the valve cavity. The valve body also includes a port at an end of the second passage (serving, e.g., as the “outlet” passage), where the second passage joins and creates a flow path from the valve cavity. The valve cavity is further defined, in part, by a surface of the valve body sloping from the valve seat down to the port of the second passage when the valve body is oriented such that the second passage extends downward from the valve cavity.

A flexible diaphragm including a protruding, rounded boss is mounted with the boss aligned with the valve seat to contact and seal the valve seat and close the flow path from the aligned passage into the valve cavity when a compressive load is applied to the flexible diaphragm to flex the diaphragm and axially displace the boss toward the valve seat.

Where the passage that is aligned with the boss is utilized as the “inlet” passage, regulation of fluid flow through the diaphragm valve from the inlet passage through the valve cavity to the “outlet” passage is achieved by flexing the diaphragm to displace the rounded boss into contact with the valve seat and sealing the valve seat to prevent fluid flow from the inlet passage into the valve cavity and allowing fluid in the valve cavity to then drain down the sloped surface into the outlet port.

In particular embodiments, two or more valves are aligned in parallel and/or in series with a common actuation mechanism (e.g., pneumatic, electronic or fully mechanical) so that valve openings and closings can be synchronized to provide simultaneous intermixing of fluids and/or to provide synchronized delivery of fluids.

With this design, the valve can provide better drainage of fluids from the valve due to the depressed positioning of the port to the second passage; this feature is particularly advantageous when the valve is used, e.g., in a bioreactor where design features that reduce entrapment of bacteria in the valve as the valve is drained and that reduce shear forces acting on cells flowing in a fluid through the valve are particularly advantageous. Another application where improved draining to remove contaminants is particularly advantageous is found where the valve is used to control the flow of de-ionized water into and out of a semiconductor processing tool to clean the processing chamber.

The valve can also provide better sealing of the input port due to the rounded surfaces on the diaphragm boss and on the valve seat. The complimentary curved surfaces on the boss and valve seat allow the seal to grow tighter when the boss is held in compression against the valve seat due conforming cold flow of the boss about the valve seat. Further still, the valve can provide a reduced pressure drop across the valve, less shearing of fluids flowing through the valve, and also reduced contamination due to the absence of O-rings in the flow stream, which can harbor microbes when present.

The diaphragm can precisely control the flow of fluids through the valve, and the design of the valve cavity can enable improved drainage of fluids from the valve.

### BRIEF DESCRIPTION OF THE DRAWINGS

FIG. 1 is a sectional view of a drainable radial diaphragm valve.

FIG. 2 is a detailed view of a section from FIG. 1.

FIG. 3 is a detailed view of another section from FIG. 1.

FIG. 4 is a top view of a drainable radial diaphragm valve.

FIG. 5 is a top view of an alternative embodiment of the drainable radial diaphragm valve, wherein the outlet passage is at an acute angle relative to the inlet passage.

FIG. 6 is a sectional view of an embodiment of the diaphragm.

FIG. 7 is a top view of a valve system including a plurality of drainable radial diaphragm valves in series.

FIG. 8 is a sectional view of a sanitary back pressure regulator.

FIG. 9 provides a perspective view of a double-sided radial diaphragm valve.

FIG. 10 provides a perspective view of the opposite side of the radial diaphragm valve of FIG. 9 (with the valve rotated approximately 180° about a horizontal axis on the page from its orientation in FIG. 9).

FIG. 11 is a sectional view of a sanitary gradient mixing valve configuration.

FIG. 12 is a sectional view of a sanitary mixing or diverting valve configuration.

The foregoing and other features and advantages of the invention will be apparent from the following, more-particular description. In the accompanying drawings, like reference characters refer to the same or similar parts throughout the different views. The drawings are not necessarily to scale, emphasis instead being placed upon illustrating particular principles, discussed below.

### DETAILED DESCRIPTION

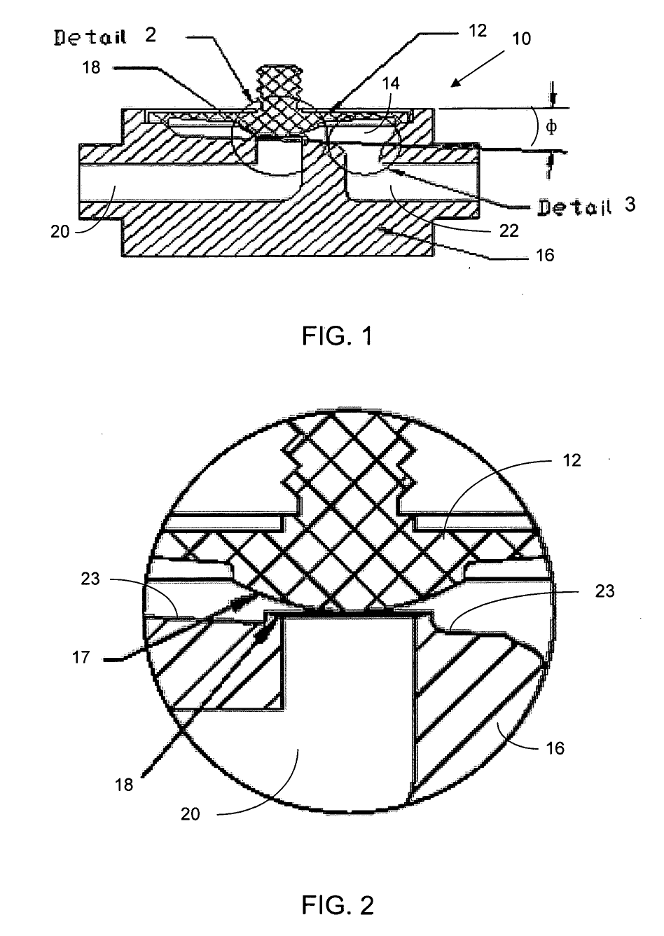

As shown in FIG. 1, a drainable radial diaphragm valve 10 includes a valve cavity 14 defined by a valve body 16 formed, e.g., of stainless steel. Other corrosion-resistant metals, such as INCONEL alloys (from Special Metals Corporation, headquarted in Huntington, W. Va., USA) and titanium (for high-purity applications) can also be used. A flexible diaphragm 12 includes a centrally positioned raised boss 17 that forms a radial seal against a valve seat 18 (shown in FIG. 2). This centrally located raised boss 17 has a dome shape that is symmetrical about a central axis 19 (along which the boss 17 is displaced) and is positioned directly over a terminal of an inlet or outlet circular passage (20 and 22) and serves as the sealing interface between the valve seat 18 and diaphragm 12 when fluid flow is stopped. In the embodiment of FIG. 1, both the inlet passage 20 and the outlet passage 22 extend substantially parallel to the central axis 19 for a length and then bends at about 90° to extend away from the central axis 19.

The valve shown in FIG. 1 has a lateral width of about 2 inches, with the depth of the valve (measured orthogonal to the plane of the drawing) also being about 2 inches. The size of the valve can also be scaled up or down (e.g., by 25, 50 or 100%) to meet system requirements. The flexible diaphragm is formed of a flouropolymer, such as polytetrafluoroethylene (PTFE). Alternatively, the diaphragm is formed of a polyferrocenylsilane (PFS), fluoroelastomer, other polymers(e.g., having plastic valve bodies), or silicone material, provided that the material is resistant to chemical attack. The use of PTFE is particularly advantageous because it can be easily machined into the desired shape without the need for expensive tooling.

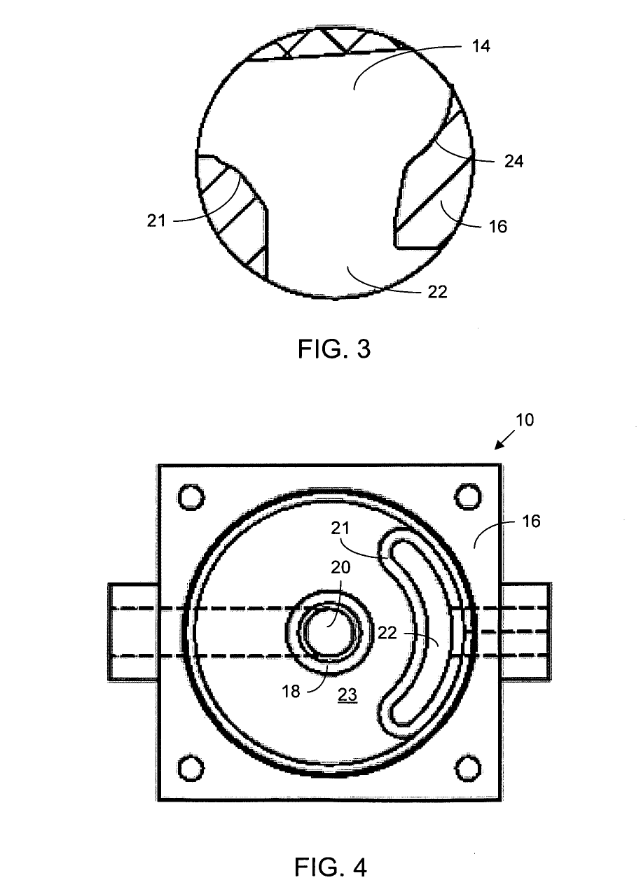

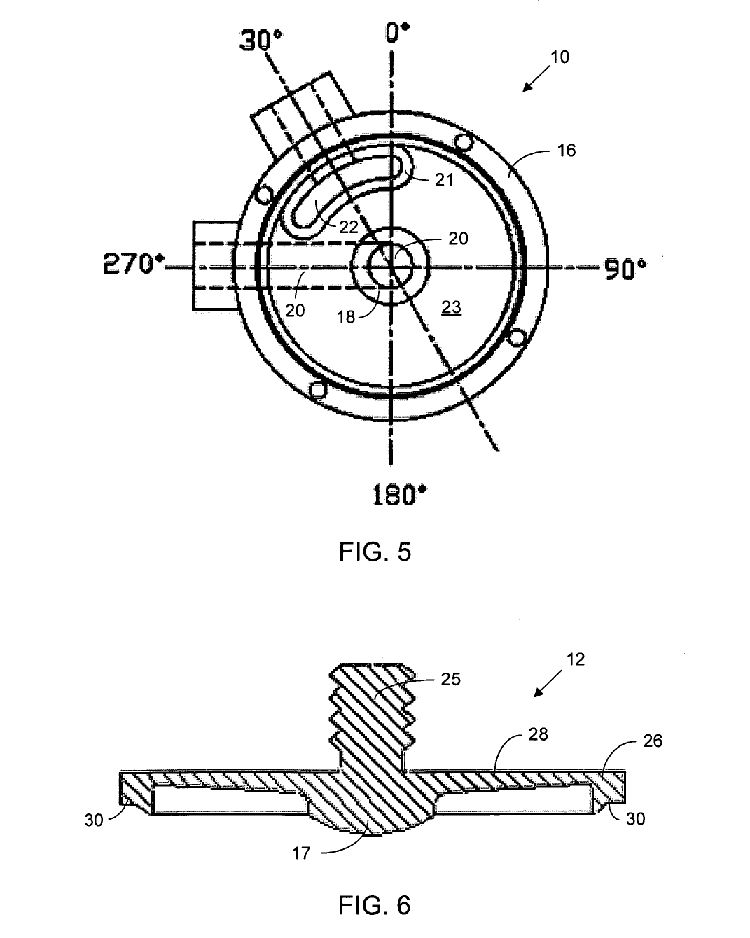

Machining of the valve seat and boss by conventional means on a sloped internal geometry would result in sealing surfaces and a through-bore that are oval in shape and difficult to seal. This issue is addressed by machining the sloped internal valve geometry and the raised boss feature into place in the same operation using a multi-axis machining center that moves along all three axes (x, y and z) at the same time, allowing for a general slope to be machined into the block and not disturbing the center axis of the seat or the through hole. As shown in FIG. 1, the internal valve cavity geometry has a phase angle (Φ) that is sloped toward the secondary tubular passage 22 to facilitate full drainage in any Polar or Cartesian coordinate (i.e., surfaces 23 slope downward toward the outlet port 21). In various embodiments of this configuration, the inlet and exit fluid passages (20 and 22) are located at angles of less than 90° (as shown in FIG. 5, with the angle measured in a horizontal plane-orthogonal to the axis along which the diaphragm is displaceable via the actuator) or up to 180° apart (as shown in FIG. 4). All of the intersecting corners 24 (see FIG. 3) of the valve cavity 14 have a radius greater and 0.032 inches to minimize entrapment areas that are not readily swept or drained of process fluids and also to reduce the fluid shear.

A circular modified diaphragm 12 is illustrated in FIG. 6. The diaphragm 12 is formed of a fluoropolymer, such as polytetrafluoroethylene (PTFE) (available as TEFLON fluoropolymer from DuPont), and is used to seal the valve cavity 14 and to act as a flexure point to seal the central flow passage 20, thus stopping the fluid flow there through. The thickness of the radial diaphragm 12, measured parallel to the central axis 19 along which the boss 17 is displaced, decreases over a flexible web region 28 with increasing radial distance from the central axis 19 of the circular profile. The radial diaphragm 12 can have a diameter (measured in a plane orthogonal to its axis of displacement) in the range, e.g., of 4 to 7 cm. The diaphragm 12 also includes an actuator fitting 25, which in this case is threaded, to which an actuator can be coupled to vertically displace the boss 17 on the other side of the diaphragm 12. The actuator fitting 25 is likewise intersected by and aligned about the central axis 19.

The outer rim 26 of the diaphragm 12 is made thicker than the central flexible web region 28, which can have a minimum and maximum web thickness of 0.015 to 0.065 inches; moreover, the outer rim 26 is beveled at its mounting surface 30 to take advantage of the fluoropolymer cold flow characteristics to achieve a reliable sealing of the valve cavity. Cold flow is a characteristic of all PTFE materials, as PTFE is not an elastic material. Cold flow occurs when the material is put into compression. When the outer rim 26 of the diaphragm 12 is clamped between the valve body 16 and actuator, the outer rim 26 is put into compression, which causes the PTFE to cold flow and form a seal that prevent fluid leakage to the outside environment. Cold flow also occurs at the central boss 17 of the diaphragm about the valve seat 18 to form a seat seal that stops fluid from flowing through the valve 10. The contacting surfaces of the boss 17 and the valve seat are both curved (i.e., rounded in planes oriented along the axis of displacement of the boss 17) to promote better sealing of the boss 17 against the valve seat 18 with cold flow.

Accordingly, cold flow of the PTFE also allows the central diaphragm boss 17 to be moved into position to seal off the central fluid passage 20. The diaphragm boss 17 has a radius of curvature (in the planes oriented along its displacement axis) to enhance the fluid dynamic flow by reducing turbulence that is usually caused by sharp edges or flat surfaces perpendicular to the direction of flow. A matching (inverse) radius of curvature can be found at the valve seat 18, providing a leak-tight sealing surface that facilitates excess fluids being pushed when closure is made (see FIG. 2).

Another feature is the angled/chamfered surfaces of the outlet port 21 at the mouth of the outlet passage 22, as shown in FIG. 3. These angled surfaces 21 allow for lower internal turbulence and increased constant velocities (CV's) of the exit fluid while minimizing pressure drop across valve 10. Furthermore, enhancing exit flow helps to assure that the exit port remains free of obstructions.

The angled outlet port 21, if at an angle greater than 90 degrees (measured in a horizontal plane—orthogonal to the axis of displacement of the diaphragm 12), reduces the fluid pressure in the valve 10. As the angle approaches 180 degrees, the pressure drop across the valve 20 is further reduced. However, to facilitate inline installations, the outlet port 21 is angled toward the centerline of the inlet passage 20 as it enters the valve 10, as shown, e.g., in FIG. 4. Beveling the porting reduces the amount of turbulence caused by the fluid coming in contact with a sharp edge and greatly reduces the amount of mechanical shear forces exerted on critical fluids flowing through the valve 10.

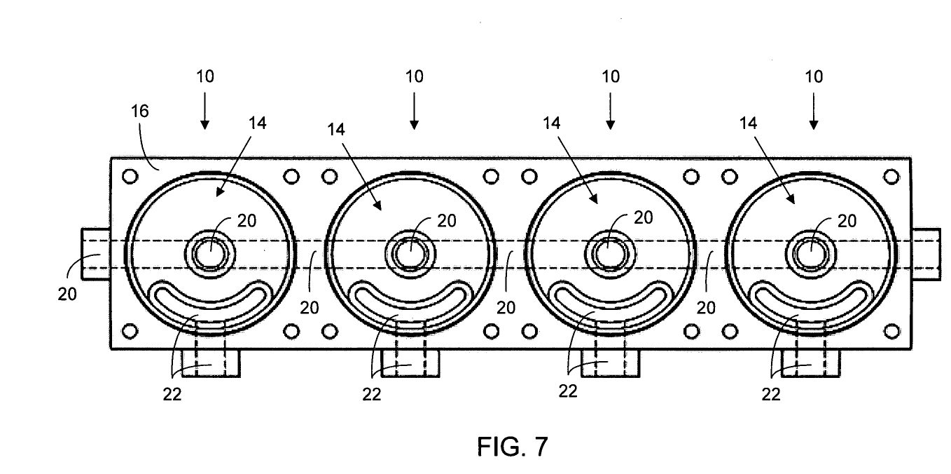

In FIG. 7, several valves 10 are coupled, in series, within a unitary valve body 16. A central flow passage 20 has ports at the center of each valve 10 through which a fluid can flow into or out of each valve chamber 14. Each valve 10 also includes a 90° depressed port leading to a passage 22 through which fluid can flow out of (or into) each valve 10. Accordingly, fluid can be selectively delivered into or out of any particular valve 10 through either of the passages 20 or 22, as desired.

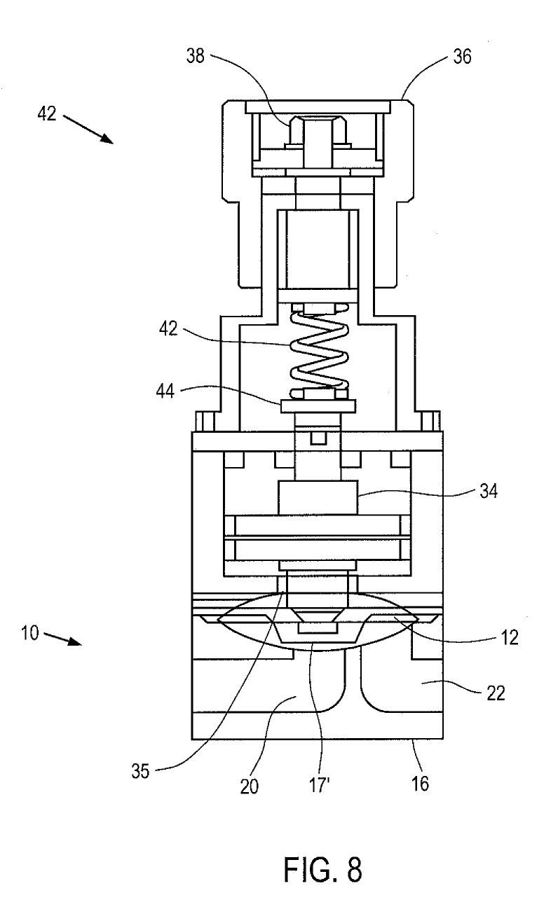

A sanitary back pressure regulator is illustrated in FIG. 8, wherein an actuator 32 is provided for regulating the valve 10. The valve 10 includes a boss 17′ that can be replaced with the rounded boss 17, described and illustrated herein. The actuator 32 is mounted to the valve body 16 and a displaceable piston 34 extends from the actuator 32 through an O-ring 35 into the valve body 16 where it is coupled with the diaphragm 12 opposite the boss 17′. Displacement of the piston 34 (and the boss 17′ by extension) is controlled via manual rotation of a knob 36. The knob 36 includes a nut 38, through which a second piston 40 is threaded for sliding axial displacement in the actuator 32. The second piston 40 is coupled with a spring 42 that can be loaded in compression. At its opposite end, the spring 42 is biased against a retainer 44 at the end of the first piston 34. With the boss 17′ accordingly biased against the valve seat in compression, the flow of fluid into the valve chamber through passage 20 can be tempered (e.g., a high pressure surge of fluid through the passage 20 will displace the boss 17′ away from the valve seat to allow a reduced flow of the fluid into the valve chamber).

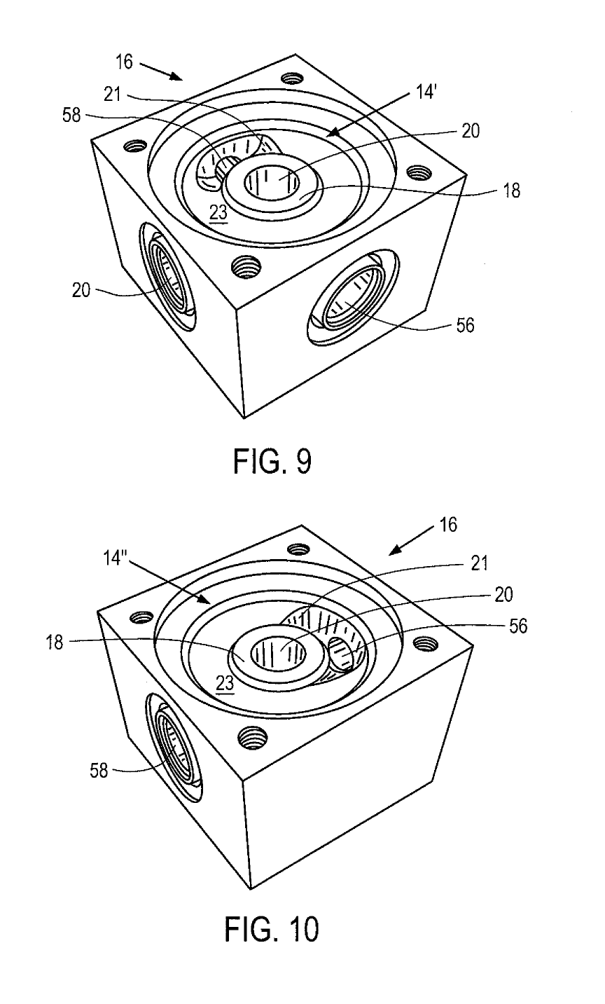

A double-sided valve with cavities on opposite sides of the valve body 16 is illustrated from opposite perspectives in FIGS. 9 and 10. FIG. 9 shows a first valve cavity 14′ with a central passage 20 providing a flow path from a port in the front-left-side face of the valve body 16 (as illustrated) through the valve seat 18. A second passage 58 connects a port 21 at a perimeter of the valve cavity 14′ with a port in the back-left-side face (hidden in this view) of the valve body 16. A port in the front-right-side face of valve body 16 provides a passage 56 to the second valve cavity 14″ (shown in FIG. 10). FIG. 10 shows this same valve body 16, with the valve body rotated about 180° about a horizontal axis that extends left-to-right across the page. In the second valve cavity 14″ shown in the opposite face in FIG. 10, the corresponding port 21 for passage 56 can be seen, and the central passage 20 can be seen to extend clear through the valve body 16 to provide a passage connecting the two valve cavities 14′ and 14″ along with the side port shown in FIG. 9 (in a sort of sideways “T”-shaped passage).

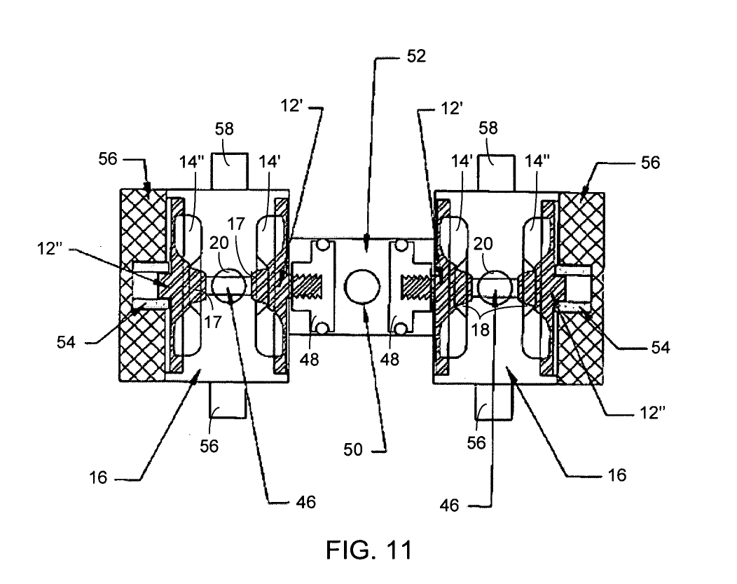

A sanitary gradient mixing valve configuration is illustrated in FIG. 11 partially in cross-section and absent illustration of all of the fluid passages defined within the valve bodies 16. The configuration includes a pair of double-sided valves 10 (as shown in FIGS. 9 and 10) with substantially identical valve cavities 14′ and 14″ on opposite sides of each valve body 16. Diaphragms 12′ and 12″, each including a central boss 17 for closing or regulating fluid flow through a central passage 20, are mounted, respectively in valve cavities 14′ and 14″. The diaphragms 12′ and 12″ on opposite sides of each valve body 16 are coupled via a connector pin 46 that passes through the central passage 20. Each of the innermost diaphragms 12′ of the structure is mounted to an actuator block 48 that is pneumatically actuated via fluid (e.g., air) pumped through a port 50 into pneumatic cylinder 52. Consequently, when air is pumped into the pneumatic cylinder 52 (e.g., from a compressed gas source), each diaphragm 12′ coupled to an actuator block 48 is pushed into the valve seat 18 such that the boss 17 of each diaphragm 12′ stops or reduces the flow of fluid between the central passage 20 and the valve cavity 14′ on the inner side of the valve body 16.

Because of the connection provided via the connector pin 46 between diaphragms 12′ and 12″, the outer diaphragm 12″ will be pushed out of the valve seat 18 to open up fluid flow between the outer valve cavity 14″ and the central passage 20 simultaneous with the reduction or closing of fluid flow between the inner valve cavity 14′ and the central passage 20 due to the displacement of the inner diaphragms 12′. Meanwhile, each outer diaphragm 12″ is mounted against a compression spring 54, which is loaded against a compression plate 56 to provide a counterforce to displace the diaphragms 12′ and 12″ back to a neutral position when the pneumatic pressure is relaxed in the pneumatic cylinder 52. Accordingly, compressed air can be added or removed from the pneumatic cylinder 52 to control the ratio of fluid flow from input conduits 56 and 58 leading into and through the respective valve cavities 14′ and 14″ in the valve bodies 16 on both sides of the pneumatic cylinder 52. The pneumatic control thereby enables gradient mixing of different fluids entering each valve cavity 14′/14″ through a perimeter passage 22 and exiting through a joint central passage 20 fed through the respective valve seats 18, wherein the fluids from the valve cavities 14′ and 14″ are mixed in the central passage 20 and then exits through a face of the valve body 16 orthogonal to the faces through which the input and output conduits 56 and 58 pass. In other embodiments, additional passages can be provided through the valve body leading into each valve cavity 14′/14″ to enable the mixing of additional fluids into the flow stream. For example, the valve body 16 can have a hexagonal (rather than square) profile, with a different passage entering through each of the six faces of the hexagon; alternatively, the valve body can be circular with several input ports around its perimeter feeding into multiple ports entering the valve cavity 14′/14″ about the central passage 20.

In alternative embodiments, the central pneumatic actuator is replaced with an electronic actuator, wherein an electrical signal is sent to one or more electrically actuated displacement mechanisms (e.g., a motor or piezoelectric material) mounted where the pneumatic cylinder 52 is in the embodiment of FIG. 11. The electrically actuated displacement mechanism is coupled with the inner diaphragm 12′ of each valve body 16 to likewise displace the boss 17 of each diaphragm 12′ into and out of the valve seat 18 to provide synchronized and simultaneous control of fluid flow through each valve body 16 (as is similarly achieved where pneumatic control is used). In still other embodiments, the actuator can be fully mechanical, wherein each of the inner diaphragms 12′ can be mechanically coupled with a common displacement structure (e.g., a rod).

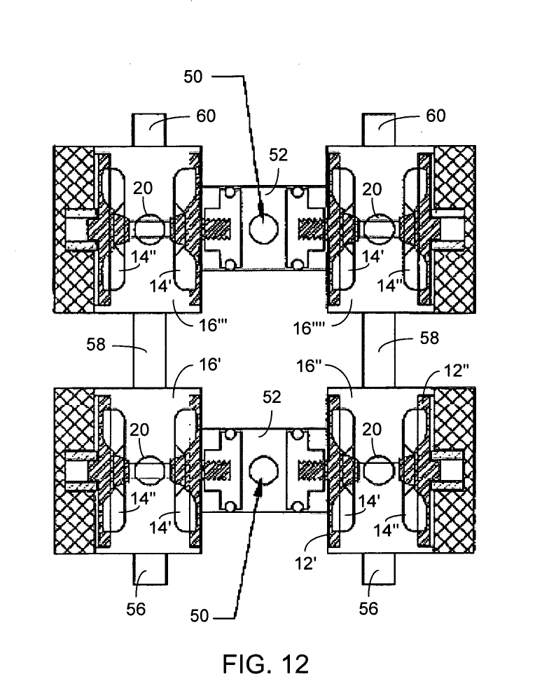

FIG. 12 is an illustration (partially in cross-section and without illustration of all of the internal passages) of a sanitary mixing or diverting valve including double-sided valve bodies 16′ and 16″ joined in parallel, as in FIG. 11, and also in series, as shown by the configuration of valves 16′ and 16′″ as well as that of valves 16″ and 16″″. Accordingly, a first fluid can be passed through a respective passage 20 entering through a side face of each of the lower valve bodies 16′ and 16″. Meanwhile, a second fluid can be passed through a respective lower passage 56 in each of the valve bodies 16′ and 16″, with the flow of the second fluid through the inner valve cavity 14′ regulated by the displacement of the inner diaphragm 12′.

The first and second fluids are then mixed in the central portion of passage 20 before entering the outer valve cavity 14″ and then exiting through passage 58 into an upper valve body 16′″/16″″. In the upper valve body 16′″/16″″, the mixed fluid is directed into the inner valve cavity 14′ from where it can be mixed with a third fluid fed in via passage 20 through the side of the valve body 16′″/16″″. Additional double-sided valves can be added in series, as desired. Each of the pneumatic cylinders 52 can be coupled to a common compressed gas supply such that each actuator can be activated in unison to simultaneously displace each diaphragm 12′/12″ in the system. Likewise, where the pneumatic actuators are replaced with electronic actuators, each of the electrical actuators can be coupled with an electronic controller that simultaneously sends electrical signals to each of the actuators. Regardless of the mechanism, the design provides precise, synchronized control without having to calibrate or modulate the mechanical pumps that pump the various fluids through the valves.

The valves 10, described herein, can be incorporated into the fluid transport lines in a variety of applications and industries, particularly where more-complete draining of fluids in the valve and maintenance of sanitary and uncontaminated fluid passages is particularly advantageous. Particular systems into which the valves 10 can be incorporated accordingly include bioreactors (particularly where biological fluids, such as human blood or liquids containing other living cells, flowing through the valve are subject to change) as well as semiconductor processing tools (where, e.g., a cleaning fluid can be passed through the valve), where the valves 10 are incorporated into one or more passages leading into and/or out of the reactor or tool to govern the flow of fluids through the passages. The valves, alone or in combination, can also be employed in fluid passages in various other high-purity or sanitary fluid distribution systems, such as chromatography systems, filtration skids, and water-for-injection systems for water distillation or reverse osmosis.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/20^{th}, 1/10^{th}, ⅕^{th}, ⅓^{rd}, ½, etc., or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention; further still, other aspects, functions and advantages are also within the scope of the invention. The contents of all references, including patents and patent applications, cited throughout this application are hereby incorporated by reference in their entirety. The appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention.

What is claimed is:

1. A drainable radial diaphragm valve comprising:
a valve body defining an inlet passage, an outlet passage, and a valve cavity;
wherein the valve body includes a valve seat at an end of the inlet passage, where the inlet passage joins and creates a flow path into the valve cavity;
wherein the valve body includes a port at an end of the outlet passage, where the outlet passage joins and creates a flow path from the valve cavity; and
wherein the valve cavity is defined, in part, by a surface of the valve body sloping from the valve seat downward to the port of the outlet passage when the valve body is oriented such that the outlet passage extends downward from the valve cavity; and
a flexible diaphragm including a protruding boss, wherein the flexible diaphragm is mounted with the boss aligned with the valve seat to contact and seal the valve seat and close the flow path from the inlet passage into the valve cavity when the flexible diaphragm is flexed to axially displace the boss toward the valve seat.

2. The drainable radial diaphragm valve of claim 1, wherein the port at the end of the outlet passage is chamfered.

3. The drainable radial diaphragm valve of claim 1, wherein the diaphragm comprises a fluoropolymer.

4. The drainable radial diaphragm valve of claim 3, wherein the fluoropolymer is polytetrafluoroethylene.

5. The drainable radial diaphragm valve of claim 1, wherein the valve body comprises stainless steel.

6. The drainable radial diaphragm valve of claim 1, wherein the flexible diaphragm has a central axis and a substantially circular sectional profile.

7. The drainable radial diaphragm valve of claim 6, wherein the flexible diaphragm includes an actuator fitting that protrudes on an opposite side of the diaphragm from the boss.

8. The drainable radial diaphragm valve of claim 7, wherein the boss and the fitting are intersected by the central axis.

9. The drainable radial diaphragm valve of claim 6, wherein the flexible diaphragm has a thickness, measured parallel to the displacement axis of the boss, that decreases over a flex region with increasing radial distance from the central axis of the circular profile.

10. The drainable radial diaphragm valve of claim 6, wherein the diaphragm further includes an outer rim protruding along the perimeter of the diaphragm in a direction substantially parallel to the displacement axis of the boss.

11. The drainable radial diaphragm valve of claim 10, wherein the outer rim includes a bevel that contacts the valve body for an enhanced seal.

12. The drainable radial diaphragm valve of claim 1, wherein the valve seat defines a circular orifice at the junction of the inlet passage and the valve cavity.

13. The drainable radial diaphragm valve of claim 12, wherein the surface of the boss that is aligned to contact and seal the valve seat is sloped radially outwardly such that an inner part of the surface extends further in a direction parallel to the displacement axis of the boss than does an outer part of the surface.

14. The drainable radial diaphragm valve of claim 13, wherein the boss is dome-shaped.

15. The drainable radial diaphragm valve of claim 13, wherein a contact surface of the valve seat that is aligned to contact the boss is inwardly sloped such that an outer edge of the valve seat extends further in a direction parallel to the displacement axis of the boss than does an inner edge of the valve seat.

16. The drainable radial diaphragm valve of claim 15, wherein the contact surface of the valve seat has substantially the same slope as the contact surface of the boss and wherein the contact surfaces have inversely matching shapes.

17. The drainable radial diaphragm valve of claim 1, wherein the inlet passage and the outlet passage both extend substantially parallel to the displacement axis of the boss for a length, beyond which each passage reaches a bend and is directed outward in a plane orthogonal to the displacement axis of the boss.

18. The drainable radial diaphragm valve of claim 1, wherein the valve is mounted in the path of a passage providing fluid flow into and/or out of a bioreactor.

19. The drainable radial diaphragm valve of claim 1, wherein the valve is mounted in the path of a passage providing fluid flow into and/or out of a semiconductor processing tool.

20. The drainable radial diaphragm valve of claim 1, wherein the valve body defines a pair of valve cavities.

21. A method for regulating fluid flow from an inlet passage to an outlet passage, the method comprising:
providing a diaphragm valve including a valve body that defines a valve cavity, an inlet passage, and an outlet passage;
wherein the inlet passage and the outlet passage along with the valve cavity define a path for fluid flow through the valve cavity;
wherein the valve body includes a valve seat at an end of the inlet passage where it joins the valve cavity and an outlet port at an end of the outlet passage where it joins the valve cavity;
wherein the valve cavity is defined, in part, by a surface sloping downward from the valve seat to the outlet port; and
wherein the diaphragm valve further includes a flexible diaphragm including a boss positioned over the valve seat;
flowing a fluid through the inlet passage, through the valve cavity and through the outlet passage; and
flexing the diaphragm to displace the boss into contact with the valve seat and sealing the valve seat to prevent fluid flow from the inlet passage into the valve cavity and allowing fluid in the valve cavity to then drain down the sloped surface into the outlet port.

22. A gradient mixing valve configuration comprising:
at least one pair of valves, each valve including:
a valve body defining at least one valve cavity and defining at least two passages entering the valve cavity to allow fluid flow into and out of the valve cavity; and
a flexible diaphragm covering the valve cavity and including a protruding boss aligned with at least one of the passages entering the valve cavity to control the flow through that passage when the flexible diaphragm is displaced into or out of the valve cavity; and
an actuator mounted between the diaphragms of the valves and coupled with the diaphragms to flex the diaphragms into or out of their respective valve cavities.

23. The gradient mixing valve configuration of claim 22, comprising a plurality of the valve pairs, wherein at least one passage in each valve body is coupled with at least one passage in one of the valves in another valve pair such that the valves are configured for fluid flow in parallel within the valve pairs and in series across the valve pairs.

24. The gradient mixing valve configuration of claim 23, wherein each of the valves is coupled with a common actuator for simultaneous adjustment of fluid flow through each of the valves.

25. The gradient mixing valve configuration of claim 22, wherein each of the valves is double-sided, with the valve body defining at least two valve cavities and with at least two passages entering into each valve cavity.
